(19) United States
(12) Patent Application Publication
(10) Pub. No.: US 2022/0106157 A1
(43) Pub. Date: Apr. 7, 2022

(54) ELEVATOR POSITION REFERENCE SYSTEMS

(71) Applicant: Otis Elevator Company, Farmington, CT (US)

(72) Inventors: Gerard Sirigu, Gien (FR); Pascal Rebillard, Gien (FR); Aurelien Fauconnet, Isdes (FR)

(21) Appl. No.: 17/398,715

(22) Filed: Aug. 10, 2021

(30) Foreign Application Priority Data
Oct. 5, 2020 (EP) 20306151.0

(51) Int. Cl. B66B 1/34

(52) U.S. Cl. CPC B66B 1/3492

(57) ABSTRACT

An elevator position reference system (1) includes a hoistway (4) extending in a vertical direction and a position measurement tape (8) arranged in the hoistway (4) to extend in the vertical direction. An upper tensioning device (10) is connected to an upper end (20) of the position measurement tape (8) so as to apply a tensioning force (30) to the position measurement tape (8) in the upwards vertical direction. A lower tensioning device (12) is connected to a lower end (22) of the position measurement tape (8) so as to apply a tensioning force (32) to the position measurement tape (8) in the downwards vertical direction.

### FOREIGN PRIORITY

This application claims priority to European Patent Application No. 20306151.0, filed Oct. 5, 2020, and all the benefits accruing therefrom under 35 U.S.C. § 119, the contents of which in its entirety are herein incorporated by reference.

### TECHNICAL FIELD

This disclosure relates to an elevator position reference system, which determines the position of a component in an elevator hoistway using a position reference or measurement tape positioned along the elevator hoistway.

### BACKGROUND

It is known to provide an elevator hoistway with a length of tape, arranged to extend vertically in the hoistway, and fixedly fastened at each end to the hoistway wall. This prior art arrangement is described in greater detail below with reference to FIG. 1. The elevator car includes a sensor e.g. a camera, able to sense certain features e.g. incremental markings, along the length of the tape, and the sensed features are used to determine the position of the elevator car within the hoistway.

It is also known to fasten static clips to the building, along the length of the hoistway, and pass the tape through these clips, such that movement of the tape at each of these clips is restricted in a horizontal direction. These clips allow free vertical movement of the tape through the clips. An example of such a clip is shown in FIG. 2, and described in greater detail below.

The accuracy and repeatability of position measurements in an elevator position reference system may depend on elongation phenomena affecting the tape due to temperature variations in the hoistway.

Certain drawbacks with such known position measurement tape arrangements have been appreciated and the elevator position reference system according to the present disclosure seeks to address these shortcomings.

### SUMMARY

According to a first aspect of this disclosure there is provided an elevator position reference system, comprising: a hoistway extending in a vertical direction; a first position measurement tape arranged in the hoistway to extend in the vertical direction; a first upper tensioning device, connected to an upper end of the first position measurement tape so as to apply a tensioning force to the first position measurement tape in the upwards vertical direction; and a first lower tensioning device, connected to a lower end of the first position measurement tape so as to apply a tensioning force to the first position measurement tape in the downwards vertical direction.

By tensioning the position measurement tape from both the upper and lower ends, any elongation of the tape arising as a result of thermal elongation is shared out equally along the length of the tensioned tape. As a result, the elongation of the tape along its length can be accurately predicted so that the impact of this elongation on a position measurement made using the tape can be accurately predicted. This helps to prevent the accuracy of a position measurement made using the position measurement tape from being negatively affected by thermal elongation of the position measurement tape.

When the hoistway is defined as extending “in a vertical direction”, it will be understood by the skilled person that this does not require the hoistway to extend precisely vertically i.e. at 90° to the horizontal direction, but rather that the direction in which the hoistway extends is substantially vertically, but may be inclined. For example, a passenger travelling in an elevator car within an inclined hoistway will still be considered to be travelling generally vertically upwards or downwards, even though the elevator car may also travel somewhat in the horizontal direction as it ascends or descends. The position measurement tape extending “in the vertical direction”, and the direction of the tensioning forces in the upwards and downwards “vertical” direction, should be similarly understood as not necessarily following a plumb line in the hoistway. Furthermore, even if the hoistway is not inclined it will be appreciated that the position measurement tape may extend generally in the vertical direction but at an angle to the true vertical, e.g. an inclined position measurement tape running along the hoistway may also be useful for position referencing any component (such as an elevator car or counterweight) moving along the hoistway.

In some embodiments, the elevator position reference system further comprises an intermediate fixing device secured at a fixing position in the hoistway and fixed to an intermediate portion of the first position measurement tape, between the upper end and the lower end of the first position measurement tape, so as to prevent vertical movement of the intermediate portion. It will be understood by the skilled person that the intermediate fixing device being secured at a fixing position in the hoistway means that the intermediate fixing device is fixed in a position so as to remain static relative to the hoistway. This advantageously helps to mitigate the effect of thermal elongation of the position measurement tape. The intermediate fixing device creates a portion of the position measurement tape, somewhere between its two ends, which cannot move vertically relative to the hoistway. Thus the tape is divided into two sub-portions by the intermediate portion, each sub-portion having a length which is isolated from the length of the other sub-portion, such that elongation of one of the sub-portions cannot alter the length of the other sub-portion. Each sub-portion will experience a thermal elongation which is proportional to its length, and each sub-portion has a length which is less than the total length of the position measurement tape, therefore the absolute elongation for a given sub-portion will be less than the total elongation length would be for the position measurement tape in the absence of the intermediate fixing device. Thus the elongation can be accounted for more easily, so that measurement accuracy is not affected.

Optionally, the intermediate fixing device comprises a fixing bracket, the fixing bracket comprising a first portion and a second portion, wherein the first portion of the fixing bracket is secured at the fixing position, and the second portion of the fixing bracket is fixed to the intermediate portion of the first position measurement tape. In some embodiments, the first portion and the second portion may be respectively level e.g. the fixing bracket may be planar. In other, alternative embodiments, the second portion is horizontally offset relative to the first portion so that the intermediate portion of the first position measurement tape is located horizontally away from the fixing position in the hoistway. The fixing bracket may be stepped between the first and second portions. It will be understood that the horizontal offset between the first portion and the second portion requires only that there is offset between the portions in at least the horizontal direction away from the fixing position. The skilled person would understand this to encompass the possibility of the first portion and the second portion also being offset in the horizontal direction substantially parallel to a surface comprising the fixing position e.g. parallel to a wall of the hoistway or to a guide rail, and/or to encompass a vertical offset between the portions. This horizontal offset advantageously moves the position measurement tape away from the fixing position and therefore from the surface or structure on which the fixing position is located e.g. the hoistway wall or guide rail, thereby preventing undesirable contact between that surface and the position measurement tape so as to reduce the risk of damage or wear to the position measurement tape.

In addition to one or more of the features described above, or as an alternative, in some embodiments the intermediate fixing device comprises a clamping plate arranged to apply pressure to a first side of the first position measurement tape so as to prevent vertical movement of the intermediate portion. This advantageously provides a simple arrangement requiring a very small number of additional components to provide satisfactory fixing of the position measurement tape so as to prevent movement in the vertical direction. The clamping plate may be clamped against an existing component e.g. a wall of the hoistway, or a guide rail, in order to apply pressure to the first side of the first position measurement tape. Alternatively, the clamping plate may be a first clamping plate, and a second clamping plate may be provided, and arranged in opposing contact with the first clamping plate so as to apply pressure to the position measurement tape, e.g. from first and second sides. In some embodiments, the clamping plate is clamped to the second portion of the fixing bracket. This advantageously allows the clamping plate to apply pressure to the position measurement tape and thereby prevent vertical movement of the clamped portion of the position measurement tape, whilst keeping the position measurement tape from contacting the surface to which the fixing bracket is fixed. In some embodiments the position measurement tape is arranged between the clamping plate and an opposing surface, and the clamping plate is fixed to the opposing surface by at least two fastening devices. This helps to ensure secure fixing of the clamping plate. In some embodiments, the fastening devices are screws or bolts. These are low cost and readily available.

In addition to one or more of the features described above, or as an alternative, in some embodiments the fixing position of the intermediate fixing device is on a wall of the hoistway. In addition to one or more of the features described above, or as an alternative, in some embodiments the elevator system comprises an elevator car guide rail or a counterweight guide rail, and the fixing position is on the elevator car guide rail or the counterweight guide rail. This allows the intermediate fixing device to be conveniently mounted on an existing structure within the hoistway.

In addition to one or more of the features described above, or as an alternative, in some embodiments the elevator position reference system further comprises a second position measurement tape, arranged in the hoistway to extend in the vertical direction below the first position measurement tape; a second upper tensioning device, connected to an upper end of the second position measurement tape so as to apply a tensioning force to the second position measurement tape in the upwards vertical direction; and a second lower tensioning device, connected to a lower end of the second position measurement tape so as to apply a tensioning force to the second position measurement tape in the downwards vertical direction. By providing two separate position measurement tapes, one below the other and each spanning a portion of the vertical extent of the hoistway, the effect of thermal elongation on each of these lengths is reduced, in comparison to one single length of tape spanning the same vertical extent.

The second position measurement tape extends in the vertical direction “below” the first position measurement tape. It will be understood that “below” means that the two position measurement tapes are generally aligned along the same vertical direction, with the second largely below the first, but that there could be a degree of overlap of the tapes along the vertical direction and/or there could be an offset between the tapes in a horizontal direction. The second position measurement tape is arranged “below” the first position measurement tape to the extent required so that ideally the first and second position measurement tapes can be followed sequentially by the same position sensor mounted on a component moving up/down in the vertical direction.

In some embodiments there may be no vertical overlap between the first and second position measurement tapes i.e. for any given vertical section of the hoistway only one position measurement tape will be present i.e. extend, across that section of the hoistway. This can help to avoid position reading errors.

In addition to one or more of the features described above, or as an alternative, in some embodiments, substantially the entire vertical extent of the hoistway is spanned by the one or more position measurement tapes. The skilled person would understand by this that any suitable number of such position measurement tapes may be provided along the length of a single hoistway, but that the tapes are arranged such that for any chosen vertical length of the hoistway, a position measurement tape will be present. In this way, wherever a component is located along the vertical length of the hoistway, it will be possible to determine the position i.e. height of the component based on signals detected from the adjacent position measurement tape.

In addition to one or more of the features described above, or as an alternative, in some embodiments the elevator position reference system further comprises a second intermediate fixing device, secured at a second fixing position in the hoistway and fixed to an intermediate portion of the second position measurement tape, between the upper end and the lower end of the second position measurement tape, so as to prevent vertical movement of the intermediate portion of the second position measurement tape. This allows the same advantages as described above in relation to the first position measurement tape to be achieved likewise for the second position measurement tape. Thus the intermediate fixing device acting to separate the second position measurement tape into multiple sub-portions can mitigate even further the effect of thermal elongation.

In addition to one or more of the features described above, or as an alternative, in some embodiments the elevator position reference system comprises a plurality of such position measurement tapes, arranged as laid out above. In some embodiments, the elevator position reference system further comprises a plurality of intermediate fixing devices, each intermediate fixing device corresponding to one of the plurality of position measurement tapes and arranged to fix an intermediate portion of the respective position measurement tape relative to the hoistway.

In some embodiments, optionally the (first and/or second) intermediate fixing device is located approximately half way between the upper end and the lower end of the respective position measurement tape. This advantageously ensures that each sub-portion of tape is the same length and therefore undergoes substantially the same elongation as a result of thermal elongation, allowing such changes to be more easily accounted for.

In addition to one or more of the features described above, or as an alternative, in some embodiments the elevator position reference system further comprises a mounting component arranged in the hoistway to mount the second upper tensioning device and the first lower tensioning device. Thus the lower end of one position measurement tape, and the upper end of the (vertically) adjacent position measurement tape are mounted to the same mounting component in the hoistway i.e. they are mounted end-to-end in the vertical direction. It will be understood by the skilled person that these position measurement tapes will therefore be adjacent to the extent defined by the length of the mounting component e.g. if the mounting component is large there may still be a moderate distance between the lower end of one position measurement tape and the upper end of the adjacent position measurement tape. This advantageously reduces the number of structures e.g. mounting brackets, which need to be fixed in the hoistway in order to implement the elevator position reference system. Moreover, if a small mounting component is used this helps to ensure that the distance between the respective ends of the position measurement tapes (i.e. the length of the hoistway in which no position measurement tape is present and therefore in which accurate position determination is not possible by this means) is kept small.

In addition to one or more of the features described above, or as an alternative, in some embodiments, one or more of the tensioning devices comprises a fixing portion and a tensioning portion, wherein the fixing portion is fixed to a first position within the elevator hoistway and the tensioning portion is connected to the upper or lower end of the first or second position measurement tape and is moveable relative to the fixing portion so as to apply the tensioning force. This allows a position measurement tape to be tensioned as a result of movement of the tensioning portion relative to the fixed portion e.g. so as to apply a pulling force on the tape. In some embodiments the one or more tensioning devices may comprise more than one tensioning portion, this allows an arrangement as described above to be formed, wherein the first lower tensioning device is provided by one tensioning portion and the second upper tensioning device is provided by the other tensioning portion, both mounted to the fixing portion. This reduces the total number of components and fixings required to form the arrangement.

In some embodiments the tensioning portion optionally comprises a resilient member (e.g. a spring) connected to the upper and/or lower end of the first and/or second position measurement tape. This provides a simple and low cost tensioning mechanism.

In some embodiments the first and/or second lower tensioning device optionally comprises a weight connected to the lower end of the first or second position measurement tape and moveable in the downwards vertical direction relative to the hoistway so as to apply the tensioning force. This provides a simple mechanism for applying a tensioning force to the lower end of a position measurement tape without requiring any fixing within the hoistway. The weight will simply apply a downwards force to the lower end of the position measurement tape due to gravity so as to tension the position measurement tape.

In addition to one or more of the features described above, or as an alternative, in some embodiments the elevator position reference system further comprises at least one tape guiding clip secured at a guiding position in the hoistway, located between the first or second upper tensioning device and the first or second lower tensioning device, and arranged in contact with the first or second position measurement tape, so as to restrict movement of the first or second position measurement tape in a horizontal direction but allow vertical movement of the first or second position measurement tape in response to the tensioning forces. These guiding clips can help to keep the first and/or second position measurement tape close to the structure on which the clips are mounted e.g. the wall of the hoistway, so as to prevent the tape from hanging loosely in the hoistway (in the event that it is not fully tensioned by the respective upper and lower tensioning devices). It will be understood by the skilled person that the guiding clip being secured at a guiding position means that it is secured in a position so as to remain static with respect to the hoistway. The guiding clip allows vertical movement of the position measurement tape relative to each clip (in contrast to the intermediate fixing device which prevents vertical movement of the portion of the position measurement tape fixed by the intermediate fixing device, so as to confine thermal elongation to respective portions of the tape) i.e. each position measurement tape is able to slide freely through such guiding clips in the vertical direction, as might happen due to extension of the tape resulting from thermal elongation.

In some embodiments, the guiding position is at a landing floor of the hoistway. For example, the elevator system may comprise a plurality of guiding clips, each secured at a respective guiding position corresponding to each landing floor of the hoistway. This helps to ensure that horizontal movement of the position measurement tape (either side to side or away from the clip mounting structure) is prevented substantially along the length of the position measurement tape.

It will be understood by the skilled person that each position measurement tape is suitable for detection by a suitable sensor, wherein the data collected by the sensor is usable to determine a position of a component within the hoistway. In some embodiments, the first and/or second position measurement tape comprises distance markings, optionally in the form of a QR code. Such markings are detectable by a sensor and can then be processed e.g. compared to a stored lookup table, to determine a position of a component within the hoistway.

The first and/or second position measurement tape described above can be used to measure the position of any component moving vertically in the hoistway e.g. a counterweight or an elevator working platform. An important use of a position measurement tape is in determining a vertical position of an elevator car within hoistway, since this information is critical to the safe and successful functioning of an elevator system. Thus, according to a second aspect of the present disclosure there is provided an elevator system having any of the features of the elevator position reference system as described herein above, and further comprising: an elevator car; and a position measurement sensor mounted on the elevator car and arranged to detect the first position measurement tape (an optionally the second position measurement tape),for determining the vertical position of the elevator car within the hoistway.

The position measurement sensor may be any suitable sensor able to establish a position measurement using the position measurement tape. For example, the position measurement sensor may be an image sensor such as a still camera or a video camera, an infra-red (IR) sensor, a magnetic sensor or a radio frequency ID (RFID) sensor. It will be understood that the position measurement tape will correspondingly include markings which can be read by the particular sensor e.g. magnetic areas or a visible pattern (such as QR codes) or a pattern of RFID tags.

### DRAWING DESCRIPTION

Some examples of this disclosure will now be described, by way of example only, with reference to the accompanying drawings, in which:

FIG. 1 shows a perspective view of an elevator system including a tape guided by clips, as is known in the art;

FIG. 2 shows a perspective view of an exemplary clip as shown in FIG. 1;

FIG. 3 shows a perspective view of an elevator system according to a first example of the present disclosure;

FIG. 4 shows a first example of a tension device according to the present disclosure;

FIG. 5 shows a second example of a tension device according to the present disclosure;

FIG. 6 shows an intermediate fixing device according to an example of the present disclosure, fixing a position measurement tape in position; and

FIG. 7 is a schematic drawing showing an elevator system according to a second example of the present disclosure.

### DETAILED DESCRIPTION

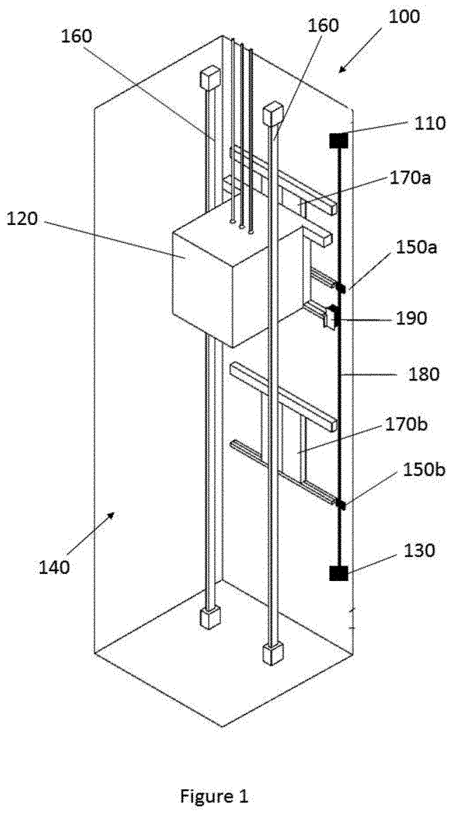

FIG. 1 shows a perspective view of an elevator system 100 as is known in the art. An elevator car 120 is arranged to move vertically within the hoistway 140, guided along guide rails 160. The hoistway 140 includes a position measurement tape 180. The position measurement tape 180 is fixed to a hoistway wall by an upper fixing device 110, connected to the upper end of the position measurement tape 180, and a lower fixing device 130, connected to the lower end of the position measurement tape 180. These fixing devices 110, 130 do not allow vertical movement of the respective ends of the position measurement tape 180. The elevator hoistway 140 also includes two guiding clips 150a, 150b. Each guiding clip 150a, 150b is located at a respective landing floor of the elevator system, close to a respective landing door arrangement 170a, 170b.

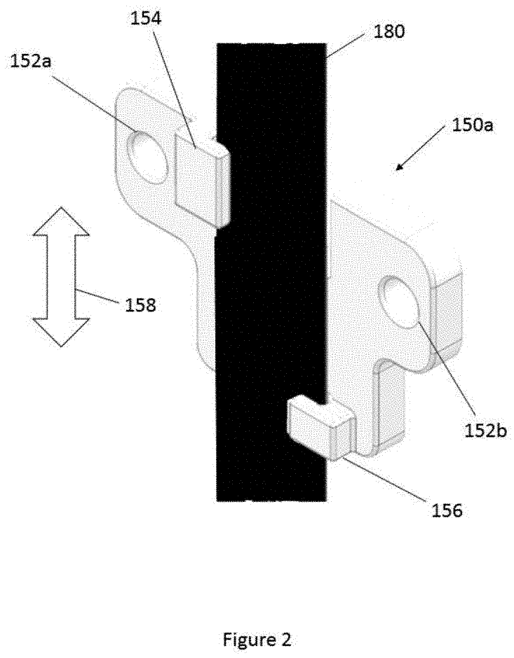

An exemplary guiding clip 150a as is known in the art is shown in greater detail in FIG. 2. The guiding clip 150a includes first and second fixing holes 152a, 152b, which allow the guiding clip 150a to be secured to a structure within the hoistway. In the example of FIG. 1 the guiding clips 150a, 150b are fixed to a wall of the hoistway 140. The guiding clip 150a includes a first protrusion 154 and a second protrusion 156 arranged such that in use they contact opposite edges of the position measurement tape 180. Thus the first protrusion 154 prevents movement of the position measurement tape 180 to the left (as viewed from the perspective of FIG. 2) whilst the second protrusion 156 prevents movement of the position measurement tape 180 to the right (also as viewed from the perspective of FIG. 2) i.e. in the event of sideways movement of the position measurement tape 180, the tape will come into contact with the first protrusion 154 or the second protrusion 156 (depending on the direction of the movement) and the protrusions 154, 156 will resist further sideways movement of the position measurement tape 180.

The protrusions 154, 156 are bent so as to also pass in front of a front surface (the surface visible in FIG. 2) of the position measurement tape 180, and thereby also prevent movement of the position measurement tape 180 in the horizontal direction away from the guiding clip 180, at least in the region of the first and second protrusion 154, 156. The first and second protrusions 154, 156 are not arranged to apply any pressure onto the front surface of the position measurement tape 180, but simply to come into contact with the position measurement tape 180 if it moves away from the guiding clip 150a so as to resist movement of the position measurement tape 180 away from the guiding clip 150a (and therefore away from the wall of the hoistway or other structure mounting the guiding clip 150a). Since the first and second protrusions 154, 156 do not apply pressure to the front surface of the position measurement tape 180, they do not restrict or hinder vertical movement of the position measurement tape 180 through the guiding clip 150a, as illustrated by the arrow 158.

The functioning of the elevator system 100 will now be explained with reference to FIGS. 1 and 2. The elevator car 120 moves vertically within the hoistway 140, along the guide rails 160, driven by any suitable drive system as is known in the art, and controlled by an elevator system controller (not shown). A sensor 190 is mounted to the elevator car 120, in a position which is aligned with the position measurement tape 180.

The sensor 190 senses position markings e.g. increments, on the position measurement tape 180 e.g. using a camera. The sensor 190 can either process the collected data itself or pass the data to another component of the elevator system e.g. the elevator system controller, for further processing. This data is processed to determine a position i.e. height, within the hoistway 140. For example, each position marking could be unique and could be looked up in a lookup table (created in an initial calibration process) which includes the corresponding height for each position marking. In this way the position measurement tape 180 is usable by the elevator system 100 to determine the vertical position of the elevator car 120 for any given position within the hoistway 140.

However, in many elevator systems 100 the height of the hoistway 140, and therefore of the position measurement tape 180, is substantial. As with any material, the position measurement tape 180 undergoes thermal expansion as a result of temperature increases in the hoistway 140, and the resulting elongation can be significant (e.g. several mm) for the lengths of position measurement tape which are commonly used. For example, the material of a typical position measurement tape may have a thermal elongation factor of 1.6×10⁻⁵ K⁻¹, which would give rise to a total length increase of 32 mm in an elevator system having a total hoistway height of 50 m, and experiencing a temperature rise of 40° C.

Since the upper and lower ends of the position measurement tape 180 of the prior art elevator system 100 are fixed to the wall of the hoistway 140, elongation of the position measurement tape 180 will create loose slack in the tape, able to freely pass through the guiding clips 150a, 150b. This therefore creates unpredictable changes and anomalies in the relative position of parts of the position measurement tape 180, since the location of any excess length of the tape cannot be accurately predicted. This can therefore result in parts of the position measurement tape moving away from their “standard” or “expected” position (e.g. during calibration), which can then negatively affect position measurements made using the position measurement tape 180.

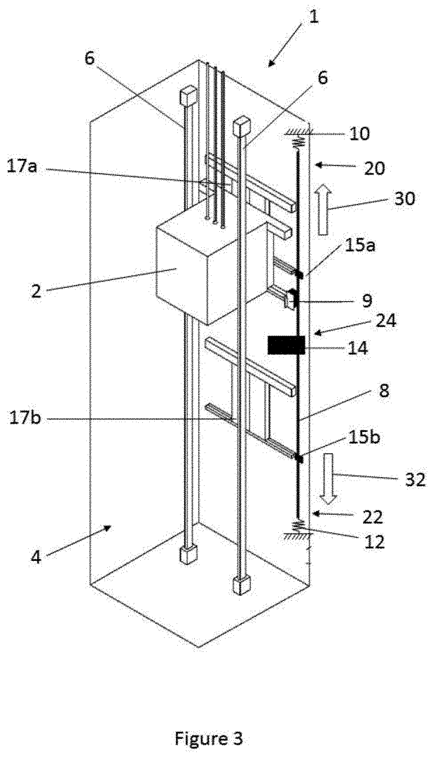

An elevator system according to the present disclosure, as described herein below with reference to FIGS. 3-7, seeks to address these shortcomings of the prior art elevator system 100.

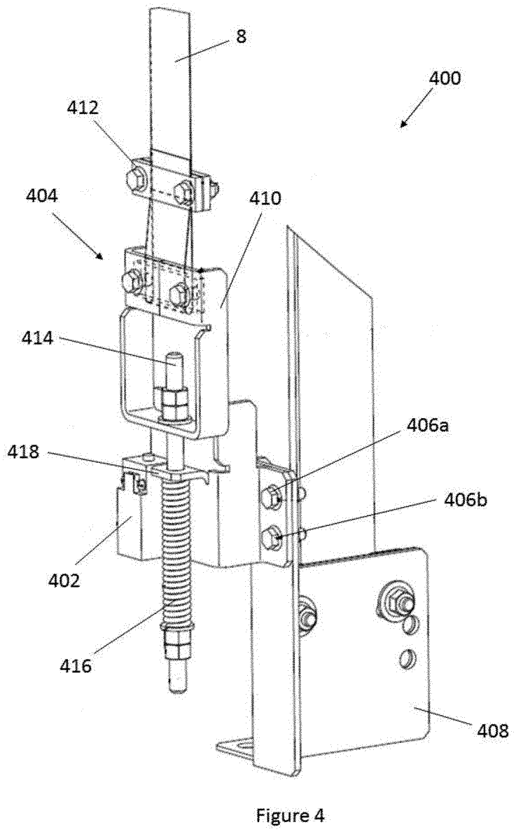

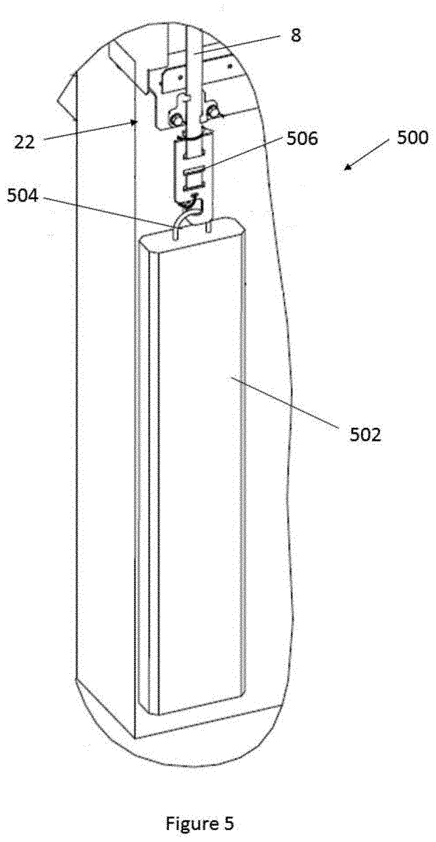

FIG. 3 shows a perspective view of an elevator system 1 according to a first example of the present disclosure. An elevator car 2 is arranged to move vertically within the hoistway 4, guided along guide rails 6. The hoistway 4 includes a position measurement tape 8. The position measurement tape 8 has an upper end 20 which is connected to an upper tensioning device 10. The position measurement tape 8 has a lower end 22 which is connected to a lower tensioning device 12. The tensioning devices 10, 12 each apply a respective tensioning force 30, 32 to the upper and lower ends 20, 22 of the position measurement tape 8, and some exemplary tensioning devices will be described in more detail with reference to FIGS. 4 and 5.

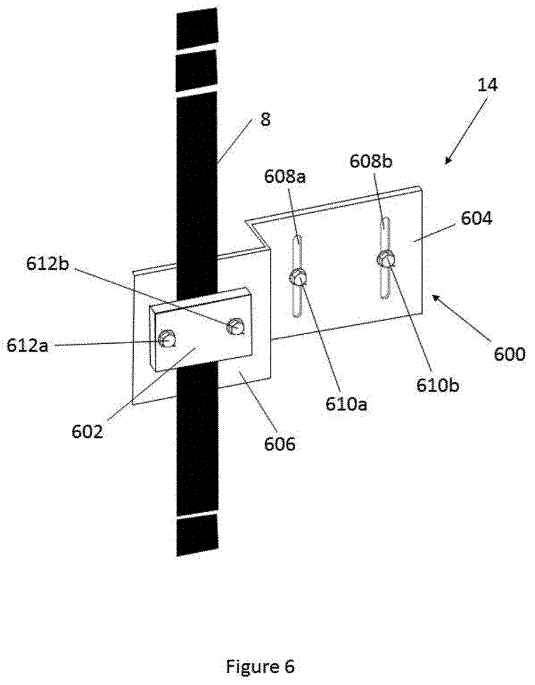

The hoistway 4 further includes an intermediate fixing device 14. The intermediate fixing device 14 is secured at a fixing position in the hoistway 4 and fixed to an intermediate portion 24 of the position measurement tape 8, between the upper end 20 and the lower end 22 of the position measurement tape 8, so as to prevent vertical movement of the intermediate portion 24. The intermediate fixing device 14 will be described in greater detail below with reference to FIG. 6.

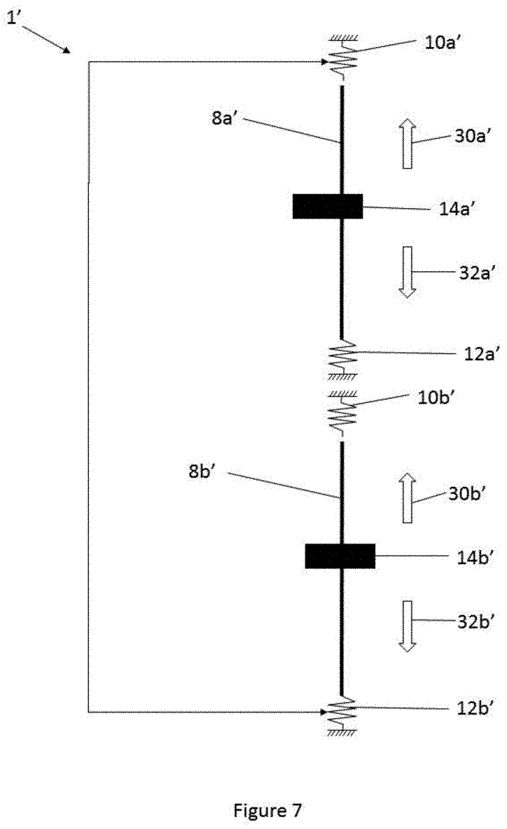

The elevator hoistway 4 also includes two guiding clips 15a, 15b. Each guiding clip 15a, 15b is located at a respective landing floor of the elevator system 1, close to a respective landing door arrangement 17a, 17b. The guiding clips 15a, 15b are the same as that described above with respect to FIG. 2 and therefore will not be described again with respect to the exemplary elevator systems of FIGS. 3 and 7.

During operation of the elevator system 1, the elevator car 2 moves vertically within the hoistway 4, along the guide rails 6, driven by any suitable drive system as is known in the art, and controlled by an elevator system controller (not shown). A sensor 9 is mounted to the elevator car 2, in a position which is aligned with the position measurement tape 8.

The sensor 9 senses position markings e.g. increments, on the position measurement tape 8 e.g. using a camera. The sensor 9 can either process the collected data itself or pass the data to another component of the elevator system e.g. the elevator system controller, for further processing. This data is processed to determine a position i.e. height, within the hoistway 4. For example, each position marking could be unique and could be looked up in a lookup table which includes the corresponding height for each position marking. In this way the position measurement tape 8 is usable by the elevator system 1 to determine the vertical position of the elevator car 2 for any given position within the hoistway 4.

The upper tensioning device 10 applies an upwards tensioning force, illustrated by upwards arrow 30. The lower tensioning device 12 applies a downwards tensioning force, illustrated by downwards arrow 32. These tensioning forces keep the position measurement tape 8 taut at all times, so any elongation resulting from thermal expansion is shared out equally along the length of the position measurement tape 8. Additionally, the intermediate fixing device 14 prevents vertical movement of the intermediate portion 24 of the position measurement tape 8. As a result, the position measurement tape 8 is isolated into two sub-portions, and elongation of one sub-portion cannot affect the other sub-portion, therefore reducing the impact on position measurement accuracy of any elongation of the tape.

FIG. 4 shows a first exemplary tensioning device 400. This could be used as an upper tensioning device 10 or a lower tensioning device 12. The tensioning device 400 has a fixing portion 402 and a tensioning portion 404. The fixing portion 402 in this example is in the form of a bracket which includes two holes 406a, 406b, through which fixing members (which in this example are bolts) can be passed to attach the fixing portion to a structure 408 within the hoistway 4, to fix the fixing portion 402 relative to the hoistway 4. The structure 408 may, for example, be a second bracket which is itself attached e.g. bolted, to a guide rail. The fixing portion 402 also includes a tensioning plate 418, described further below.

The tensioning portion 404 is connected to an end of the position measurement tape 8 (which could be the upper end or the lower end) and is moveable relative to the fixing portion 402 so as to apply the tensioning force to the position measurement tape 8. Specifically the end of the tension member 8 is looped around a first end of a tensioning bracket 410, and this tape end is then looped back to lie against the position measurement tape 8. The end of the position measurement tape is fixed in position relative to the rest of the position measurement tape 8 by a clamping mechanism 412, in which plates are arranged with the position measurement tape 8 and its end between the plates, and then fixed in opposing contact by the clamping mechanism. The other end of the tensioning bracket 410 is fixed on a rod 414. A resilient member 416, which in this example is a spring, is arranged on the rod 414, at the end which is further from the mounting bracket 414. The resilient member 416 is braced against the tensioning plate 418 of the fixing portion 402. The tensioning plate 418 includes a hole sized so that the rod 414 passes through the hole, but the resilient member 416 does not. Thus the rod 414 is able to slide through the hole, relative to the tensioning plate 418 which remains fixed relative to the hoistway (since it is part of the fixing portion 402).

When the position measurement tape 8 is installed, the resilient member 416 is pre-compressed, so that the resilient member 416 is acting to try to expand, and therefore pushing against the tensioning plate 418 (which resists since it is fixed), causing a pull on the tensioning bracket 410, downwards (with respect to the view of FIG. 4) so as to apply tension to the position measurement tape 8. If the position measurement tape 8 elongates due to thermal expansion then this will allow the resilient member 416 to expand slightly, moving the tension bracket 410 downwards (with respect to the view of FIG. 4) and ensuring that the position measurement tape 8 is kept taut. Similarly a reduction in length will apply a greater upwards force and re-compress the resilient member 416.

FIG. 5 shows a second exemplary tensioning device 500. This could be used as a lower tensioning device 12. The tensioning device 500 includes a weight 502. The weight includes a hook 504, to which a connection member 506 is attached. The lower end 22 of the position measurement tape 8 is also attached to the connection member 506. Gravity acts on the weight 502 to produce a downwards force which the position measurement tape 8 resists with its material strength i.e. resisting stretching of the tape. The force produced by the weight 502 acts to tension the positon measurement tape 8, such that if the position measurement tape 8 elongates due to thermal expansion the end 22 of the position measurement tape 8, and therefore the connection member 506 and the weight 502 to which it is connected will be able to move further downwards relative to the hoistway under the force of gravity, therefore keeping the position measurement tape 8 under tension. The weight 502 provides a tensioning mechanism which does not need to be fixed in the hoistway (and in fact works as a result of movement of the tensioning device 500 relative to the hoistway).

FIG. 6 shows an exemplary intermediate fixing device 14 as shown in FIG. 3, in more detail. The intermediate fixing device 14 includes a fixing bracket 600 and a clamping plate 602. The fixing bracket 600 has a first portion 604 and a second portion 606. The first portion 604 includes two slots 608a, 608b, though which fasteners 610a, 610b e.g. bolts, are passed, so as to secure the first portion 604 at a fixing position, which in this example is on the hoistway wall.

The clamping plate 602 is fastened by means of two fasteners 612a, 612b, to the second portion 606 of the fixing bracket 600. The position measurement tape 8 is arranged between the clamping plate 602 and the second portion 606, so as to be clamped in place such that vertical movement of the clamped portion of the position measurement tape 8 is prevented.

As seen in the view of FIG. 6, the second portion 606 is horizontally offset from the first portion 604, both in the “side-to-side” direction (as viewed in FIG. 6) and the orthogonal direction (out of the page), such that the resulting offset is overall a diagonal offset. The offset of the second portion 606 away from the structure to which the first portion 604 is secured (out of the page with reference to FIG. 6) e.g. away from the hoistway wall, prevents the position measurement tape 8 from contact with this structure e.g. the hoistway wall or a guide rail, and thus preventing wear.

FIG. 7 is a schematic drawing showing an elevator system 1′ according to a second example of the present disclosure. This elevator system 1′ is similar to the elevator system 1 described with reference to FIG. 3, and similar features will not be described again. However instead of a single length of position measurement tape 8, two different lengths of position measurement tape are present, as described below. The hoistway (not shown) includes a first position measurement tape 8a′ and a second position measurement tape 8b′. The first position measurement tape 8a′ has an upper end which is connected to a first upper tensioning device 10a′, and a lower end which is connected to a first lower tensioning device 12a′. Similarly, the second position measurement tape 8b′ has an upper end which is connected to a first upper tensioning device 10b′, and a lower end which is connected to a first lower tensioning device 12b′. The first and second upper tensioning devices 10a′, 10b′ apply respective upwards tensioning forces 30a′, 30b′, represented by arrows in FIG. 7. The first and second lower tensioning devices 12a′, 12b′ apply respective downwards tensioning forces 32a′, 32b′, represented by arrows in FIG. 7. The tensioning devices 10a′, 12a′, 10b′, 12b′ may be of the types described above with reference to FIGS. 4 and 5. The tensioning devices 10a′, 12a′, 10b′, 12b′ act to keep the respective first and second position measurement tapes 8a′, 8b′ taut and thereby reduce any measurement inaccuracies resulting from elongation of each position measurement tape 8a′, 8b′ caused by thermal expansion.

Although not shown in FIG. 7, the elevator system 1′ may also include guiding clips as are present in the embodiment of FIG. 3, and as described above with reference to FIG. 2.

Although not shown in FIG. 7, the first lower tensioning device 12a′ and the second upper tensioning device 10b′ may be mounted to the same mounting component e.g. a structure 408 as described with reference to FIG. 4 may be provided with multiple mounting locations for mounting multiple fixing portions, or a fixing portion 402 may be constructed so as to enable attachment of multiple tensioning portions 404 to a single fixing portion. This helps to reduce the number of additional components required to mount multiple lengths 8a′, 8b′ of position measurement tape.

Using two separate position measurement tapes 8a′, 8b′ to span the vertical height of the hoistway, rather than one long tape, results in each position measurement tape 8a′, 8b′ being shorter. Tape elongation is proportional to the length of the position measurement tape, and therefore the use of these shorter position measurement tapes 8a′, 8b′ ensures that the absolute (i.e. as opposed to proportional) increase in length of the position measurement tape 8a′, 8b′ as a result of thermal expansion is lower (for each tape length individually) and can therefore be more easily accounted for and creates smaller measurement errors.

In addition to this effect, reduced measurement accuracy resulting from thermal elongation of the first and second position measurement tapes 8a′, 8b′ can be further mitigated by including (optional) first and/or second intermediate fixing devices 14a′, 14b′. The first and/or second intermediate fixing devices 14a′, 14b′ may be of the type described above with reference to FIG. 6. The first intermediate fixing device 14a′ prevents vertical movement of an intermediate portion of the first position measurement tape 8a′, and similarly the second intermediate fixing device 14b′ prevents vertical movement of an intermediate portion of the second position measurement tape 8b′. This helps to further reduce the negative impact of thermal elongation on position measurement accuracy, as described above with reference to FIG. 3.

It will be appreciated by those skilled in the art that the disclosure has been illustrated by describing one or more examples thereof, but is not limited to these examples; many variations and modifications are possible, within the scope of the accompanying claims.

What is claimed is:

1. An elevator position reference system (1, 1′), comprising:
a hoistway (4) extending in a vertical direction;
a first position measurement tape (8, 8a′, 8b′) arranged in the hoistway (4) to extend in the vertical direction;
a first upper tensioning device (10, 10a′, 10b′), connected to an upper end (20) of the first position measurement tape (8, 8a, 8b″) so as to apply a tensioning force (30, 30a′, 30b′) to the first position measurement tape (8, 8a′, 8b′) in the upwards vertical direction; and
a first lower tensioning device (12, 12a′, 12b′), connected to a lower end (22) of the first position measurement tape (8, 8a′, 8b′) so as to apply a tensioning force (32, 32a′, 32b′) to the first position measurement tape (8, 8a′, 8b′) in the downwards vertical direction.

2. The elevator position reference system (1, 1′) of claim 1, further comprising an intermediate fixing device (14, 14a′, 14b′) secured at a fixing position in the hoistway (4) and fixed to an intermediate portion (24) of the first position measurement tape (8, 8a′, 8b′), between the upper end (20) and the lower end (22) of the first position measurement tape (8, 8a′, 8b′), so as to prevent vertical movement of the intermediate portion (24).

3. The elevator position reference system (1, 1′) of claim 2, wherein the intermediate fixing device (14, 14a′, 14b′) comprises a fixing bracket (600), the fixing bracket (600) comprising a first portion (604) and a second portion (606), wherein the first portion (604) of the fixing bracket (600) is secured at the fixing position, and the second portion (606) of the fixing bracket (600) is fixed to the intermediate portion of the first position measurement tape (8, 8a′, 8b′), wherein the second portion (606) is horizontally offset relative to the first portion (604) so that the intermediate portion of the first position measurement tape (8, 8a′, 8b′) is located horizontally away from the fixing position in the hoistway (4).

4. The elevator position reference system (1, 1′) of claim 2, wherein the intermediate fixing device (14, 14a′, 14b′) comprises a clamping plate (602) arranged to apply pressure to a first side of the first position measurement tape (8, 8a′, 8b′) so as to prevent vertical movement of the intermediate portion (24).

5. The elevator position reference system (1, 1′) of claim 2, wherein the fixing position is on a wall of the hoistway (4).

6. The elevator position reference system (1, 1′) of claim 2, wherein the elevator system (1, 1′) comprises an elevator car guide rail (6) or a counterweight guide rail, and the fixing position is on the elevator car guide rail (6) or the counterweight guide rail.

7. The elevator position reference system (1′) of claim 1, further comprising a second position measurement tape (8b′), arranged in the hoistway to extend in the vertical direction below the first position measurement tape (8a′);
a second upper tensioning device (10b′), connected to an upper end of the second position measurement tape (8b′) so as to apply a tensioning force (30b′) to the second position measurement tape (8b′) in the upwards vertical direction; and
a second lower tensioning device (12b′), connected to a lower end of the second position measurement tape (8b′) so as to apply a tensioning force (32b′) to the second position measurement tape (8b′) in the downwards vertical direction.

8. The elevator position reference system (1′) of claim 7, further comprising a mounting component (408) arranged in the hoistway (4) to mount the second upper tensioning device (10b′) and the first lower tensioning device (12, 12′a′).

9. The elevator position reference system (1′) of claim 7, further comprising a second intermediate fixing device (14b′), secured at a second fixing position in the hoistway (4) and fixed to an intermediate portion of the second position measurement tape (8b′), between the upper end and the lower end of the second position measurement tape (8b′), so as to prevent vertical movement of the intermediate portion of the second position measurement tape (8b′).

10. The elevator position reference system (1, 1′) of claim 1, wherein one or more of the tensioning devices (10, 10a′, 10b′, 12, 12a′, 12b′) comprises a fixing portion (402) and a tensioning portion (404), wherein the fixing portion (402) is fixed to a first position within the hoistway (4) and the tensioning portion (404) is connected to the upper or lower end of the first or second position measurement tape (8, 8a′, 8b′) and is moveable relative to the fixing portion (402) so as to apply the tensioning force (30, 30a′, 30b′, 32, 32a′, 32b′).

11. The elevator position reference system (1, 1′) of claim 10, wherein the tensioning portion (404) comprises a resilient member (416) connected to the upper or lower end of the first or second position measurement tape (8, 8a′, 8b′).

12. The elevator position reference system (1, 1′) of claim 1, wherein the first and/or second lower tensioning device (10, 10a′, 10b′, 12, 12a′, 12b′) comprises a weight (502) connected to the lower end of the first or second position measurement tape (8, 8a′, 8b′) and moveable in the downwards vertical direction relative to the hoistway (4) so as to apply the tensioning force (32, 32a′, 32b′).

13. The elevator position reference system (1, 1′) of claim 1, further comprising at least one tape guiding clip (15a, 15b) secured at a guiding position in the hoistway (4), located between the first or second upper tensioning device (10, 10a′, 10b′) and the first or second lower tensioning device (12, 12a′, 12b′), and arranged in contact with the first or second position measurement tape (8, 8a′, 8b′), so as to restrict movement of the first or second position measurement tape (8, 8a′, 8b′) in a horizontal direction but allow vertical movement of the first or second position measurement tape (8, 8a′, 8b′) in response to the tensioning forces (30, 32, 30a′, 32a′, 30b′, 32b′).

14. The elevator position reference system (1, 1′) of claim 13, wherein the guiding position is at a landing floor of the hoistway (4).

15. An elevator system comprising the elevator position reference system (1, 1′) of claim 1, and further comprising:
an elevator car (2); and
a position measurement sensor (9) mounted on the elevator car (2) and arranged to detect the first position measurement tape (8, 8a′, 8b′) for determining the vertical position of the elevator car (2) within the hoistway (4).
